(19) United States
(12) Patent Application Publication
(10) Pub. No.: US 2026/0245255 A1
(43) Pub. Date: Aug. 20, 2026

(54) EDGEBREAKER MESH CODING WITH ALTERNATIVE VERTEX TRAVERSALS

(71) Applicant: InterDigital CE Patent Holdings, SAS, Paris (FR)

(72) Inventors: Jean-Eudes Marvie, Plerin (FR); Olivier Mocquard, Rennes (FR)

(21) Appl. No.: 19/489,528

(22) PCT Filed: Jun. 25, 2024
(86) PCT No.: PCT/EP2024/067733

§ 371 Date: Dec. 2, 2025

(30) Foreign Application Priority Data
Jul. 7, 2023 (EP) 23306154.8

(51) Int. Cl. G06T 9/00

(52) U.S. Cl. CPC G06T 9/001

(57) ABSTRACT

Example embodiments provide encoding and decoding methods and apparatus for coding of mesh data. In example embodiments of a mesh encoding method, input information is obtained defining at least one connected component of a mesh, the connected component having a plurality of vertices including a plurality of dummy vertices. During a first traversal of the connected component to encode a topology of the connected component, an index is assigned to each vertex representing an order in which the vertex is visited in the first traversal. At least one attribute of the connected component is encoded using a second traversal of the connected component, the second traversal using a different traversal order than the first traversal. A table is encoded identifying the dummy vertices, each dummy vertex being identified by its associated index. The table of dummy vertices may be sorted in an ascending order of indices.

### CROSS REFERENCE

The present application claims the priority of European Patent Application No. 23306154.8, filed 7 Jul. 2023, entitled “Edgebreaker Mesh Coding with Alternative Vertex Traversals,” which is incorporated herein by reference in its entirety.

### BACKGROUND

The present disclosure relates to systems and methods for encoding and decoding a mesh based on edgebreaker technology. Edgebreaker is a technology that is capable of efficiently coding the connectivity of a triangular mesh. In its most straightforward implementation, a mesh encoded using edgebreaker is represented by an ordered series made up of the symbols, C, L, E, R, and S, called the “CLERS” sequence. Generally speaking, starting with an initial triangle, these symbols describe different ways to attach a new triangle, providing information on whether or how different edges of the new triangle are connected to one or more of the existing triangles. Edgebreaker technology is described in greater detail, for example in the following sources:
J. Rossignac, “3D compression made simple: Edgebreaker with ZipandWrap on a corner-table,” in Proceedings International Conference on Shape Modeling and Applications, Genova, Italy, 2001. Desribes decoding in a forward direction with the use of a corner table (CT) representation of the mesh, which leads to a very compact algorithm.
H. Lopes, G. Tavares, J. Rossignac, A. Szymczak and A. Safonova, “Edgebreaker: a simple compression for surfaces with handles,” in ACM Symposium on Solid Modeling and Applications, Saarbrucken, 2002.
J. Rossignac, “Edgebreaker: Connectivity compression for triangle meshes,” GVU center, Georgia Institute of Technology, 1999. Describes decoding in a forward direction using a half-edge representation.
J. Rossigniac, “Course on triangle meshes and corner table,” 2006.
M. Isenburg and J. Snoeyink, “Spirale Reversi: Reverse decoding of the Edgebreaker encoding,” Computational Geometry, vol. 20, pp. 39-52, 2001. Describes the “spiral reversi” technique, which uses a half edge representation, but performing the decoding in a reverse manner, which leads to faster decoding of O(n).

Following the MPEG V-Mesh (now renamed V-DMC) call for proposals the solution proposed by Apple was selected to become the foundation of the MPEG V-Mesh Test Model (TM). The proposal is described in K. Mammou, J. Kim, A. Tourapis and D. Podborski, “m59281—[V-CG] Apple's Dynamic Mesh Coding CfP Response,” Apple Inc, 2022. Summary figures depicting intra coding from the proposal are provided in FIG. 1 and FIG. 2 of the present disclosure.

The test model, for some frames, uses a static mesh coder for the encoding of a base mesh that is then subdivided to obtain an approximation of the original mesh. Early versions of the V-Mesh test model encode a base mesh using the Google Draco implementation of an edgebreaker-based mesh encoder. Specifically, the implementation uses the “spirale reversi” version of edgebreaker as described in M. Isenburg and J. Snoeyink, “Spirale Reversi: Reverse decoding of the edgebreaker encoding,” Computational Geometry, vol. 20, pp. 39-52, 2001.

Version 4.0 of the test model (TM) of VDMC performs static mesh coding using the MPEG EdgeBreaker (MEB) implementation presented in J.-E. Marvie and O. Mocquard, “m63344-[V-DMC] [EE4.4]-an-efficient-Edgebreaker-implementation,” MPEG meeting 142, Antalya (hereinafter “Marvie & Mocquard”). Such static mesh coding is performed at the blocks “Static Mesh Coder” and “Static Mesh decoder” of FIG. 1 and FIG. 2).

While edgebreaker coding provides an efficient way to code the connectivity of a base mesh, it has certain limitations. For example, edgebreaker coding on its own is effective only for manifold surfaces whithout “holes” or “handles.” Additional processing is required to bring such non-manifold surfaces into a format that is capable of being coded using edgebreaker technology. Moreover, edgebreaker coding on its own only codes for the connectivity of a mesh. The CLERS sequence itself does not code additional properties of a mesh, such as the locations of the vertices and any other attributes of the vertices (such as color, normal direction, UV coordinates, and the like).

### SUMMARY

A mesh encoding method according to some embodiments comprises: obtaining input information defining at least one connected component of a mesh, the connected component having a plurality of vertices including a plurality of dummy vertices; during a first traversal of the connected component to encode a topology of the connected component, assigning an index to each vertex representing an order in which the vertex is visited in the first traversal; encoding at least one attribute of the connected component using a second traversal of the connected component, the second traversal using a different traversal order than the first traversal; and encoding a table identifying the dummy vertices, each dummy vertex being identified by its associated index.

A mesh encoding apparatus according to some embodiments comprises one or more processors configured to perform at least: obtaining input information defining at least one connected component of a mesh, the connected component having a plurality of vertices including a plurality of dummy vertices; during a first traversal of the connected component to encode a topology of the connected component, assigning an index to each vertex representing an order in which the vertex is visited in the first traversal; encoding at least one attribute of the connected component using a second traversal of the connected component, the second traversal using a different traversal order than the first traversal; and encoding a table identifying the dummy vertices, each dummy vertex being identified by its associated index.

Some embodiments further include sorting the table in ascending order of the indices.

In some embodiments, obtaining input information defining at least one connected component comprises: obtaining information defining an input mesh, the input mesh having a plurality of holes; and for each of a plurality of the holes, adding a dummy vertex to fill the respective hole.

In some embodiments, the input information defining the at least one connected component of a mesh comprises a corner table.

In some embodiments, the encoding of the topology of the connected component is edgebreaker encoding.

In some embodiments, the second traversal is performed according to a vertex-degree-based traversal method. In other embodiments, the second traversal is performed according to a depth-first traversal method.

In some embodiments, the first attribute comprises at least one position coordinate of the respective vertex.

In some embodiments, the first attribute comprises at least one UV coordinate of the respective vertex.

A computer-readable medium according to some embodiments stores a mesh encoded according to any of the methods described herein.

A mesh decoding method according to some embodiments comprises: obtaining encoded information defining at least one connected component of a mesh, the connected component having a plurality of vertices including a plurality of dummy vertices; obtaining a table identifying an index of each of the dummy vertices; during a first traversal of the connected component to decode a topology of the connected component, identifying the dummy vertices based on the table; and decoding at least one attribute of the connected component using a second traversal of the connected component, the second traversal using a different traversal order than the first traversal, wherein the attribute is not decoded for the identified dummy vertices.

A mesh decoding apparatus comprising one or more processors configured to perform at least: obtaining encoded information defining at least one connected component of a mesh, the connected component having a plurality of vertices including a plurality of dummy vertices; obtaining a table identifying an index of each of the dummy vertices; during a first traversal of the connected component to decode a topology of the connected component, identifying the dummy vertices based on the table; and decoding at least one attribute of the connected component using a second traversal of the connected component, the second traversal using a different traversal order than the first traversal, wherein the attribute is not decoded for the identified dummy vertices.

In some embodiments, the table is sorted in ascending order of the indices.

In some embodiments, the decoding of the topology of the connected component is edgebreaker decoding.

### BRIEF DESCRIPTION OF THE DRAWINGS

FIG. 1 is a functional block diagram of an example mesh encoding system.

FIG. 2 is a functional block diagram of an example mesh decoding system.

FIG. 3 is a flow diagram illustrating an example of a complete edgebreaker mesh codec. The top row is the encoding line, and the bottom row is the decoding line.

FIG. 4 is a flow chart of an encoding process according to some embodiments.

FIG. 5 is a flow chart of a decoding process according to some embodiments.

FIG. 6 illustrates an example of a portion of a mesh illustrating information that may be stored in a corner table data structure.

FIG. 7 illustrates an example of an extended corner table to support UV coordinates attribute and normal vector attributes.

FIG. 8 illustrates an extended corner table data structure used in memory for the algorithmics.

FIG. 9 illustrates a process in an example embodiment in which a hole in the surface of a mesh is filled with a dummy vertex and dummy triangles.

FIGS. 10A-10B show two meshes used to illustrate prediction degree. Cross-hatched triangles are those in which all vertices have been traversed. The prediction degree of the bold vertex in FIG. 10A is four. The prediction degree of the bold vertex in FIG. 10B is three.

FIG. 11 illustrates code for an example vertex degree traversal method.

FIGS. 12A-12B illustrate code for an example depth first traversal method.

FIG. 13 illustrates code for an example encoder procedure encodeCcMainIndexAttributes.

FIG. 14 includes feature illustrated in a procedure startCompression to encode the attributes using main index with a specific traversal.

FIG. 15 illustrates code for the creation of an MI table according to some embodiments.

FIG. 16 illustrates an example of code added to the procedure encodeMainAttributes to reindex the dumy table oDummies differently in case of a different traversal than the edgebreaker one.

FIG. 17 illustrates an example of code used for ordering an oDummies table in some embodiments, with added code being shown in bold.

FIG. 18 illustrates an example of code used for a decoder procedure decodeCcMainIndexAttributes in some embodiments.

FIG. 19 illustrates examples of code that may be used in some embodiments in a procedure startDecompression to decode the attributes using a main index with a specific traversal.

FIG. 20 illustrates examples of code that may be used in some embodiments in a procedure posDecodeWithPrediction to support different available traversal modes.

FIG. 21 illustrates examples of code that may be used in some embodiments in a procedure uvDecodeWithPrediction to support all the traversal modes.

FIGS. 22A-22B illustrate examples of code that may be used in some embodiments in a procedure encodeSeparateIndexAttributes.

FIGS. 23A-23C illustrate examples of code that may be used in some embodiments in a procedure decodeSeparateIndexAttributes.

FIGS. 24A-24B illustrate performance results over 300 frames using degree traversal only for positions versus TMv4.0 Anchor. Base mesh size gains are expressed in percentages. FIG. 24A illustrates the AI condition, and FIG. 24B illustrates the LD condition.

FIGS. 25A-25B illustrate performance results over 300 frames using degree traversal for positions with main index and UV coordinates with separate index vs TMv4.0 Anchor. Base mesh size gains are expressed in percentages. FIG. 25A illustrates the AI condition, and FIG. 25B illustrates the LD condition.

FIG. 26 illustrates performance results using lossless coding over 300 frames using degree traversal for positions with main index and UV coordinates with separate index vs TMv4.0 Anchor. Base mesh size gains are expressed in percentage.

FIG. 27 is a block diagram of an example of a system in which various aspects and embodiments are implemented.

### DETAILED DESCRIPTION

### Overview of an Example Edgebreaker Codec

Edgebreaker (EB) is a technology for encoding and decoding (collectively “coding”) the topology (connectivity and handles) of the mesh, which is the core of the algorithm, and proposes the use of predictors for the positions of the vertices to generate some entropy coding efficient data.

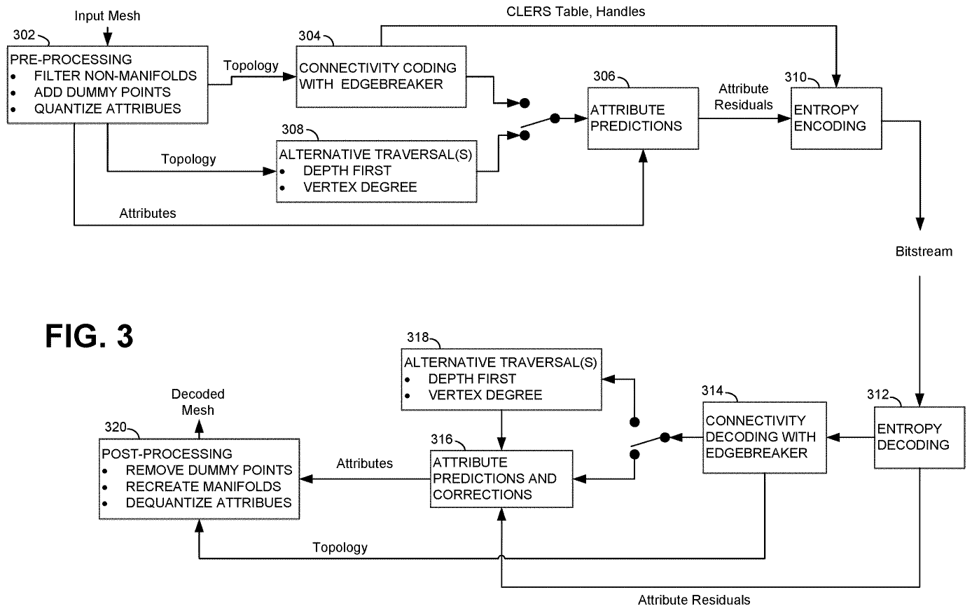

FIG. 3 illustrates an example of an edgebreaker mesh codec according to some embodiments. The top row is the encoding line, and the bottom row is the decoding line. As illustrated in FIG. 3, example embodiments include some or all of the following. During encoding, pre-processing 302 may be used to clean potential connectivity issues (non-manifolds edges and vertices) that can exist on the input mesh. This cleanup is performed because the edgebreaker algorithm by itself does not work on meshes having such connectivity issues. In some embodiments, cleaning non manifold edges and vertices involves duplicating a number of points. Some embodiments keep track of those duplicated vertices to merge those when decoding. This enables to reduce the number of points in the decoded mesh but calls for sending some additional information in the bitstream. In some embodiments, this pre-processing further includes adding some dummy points to fill potential holes on the surface because the edgebreaker algorithm alone does not handle holes. Example embodiments operate to fill the holes before encoding and recreate the holes after decoding. Example embodiments use “virtual” dummy points and generate and encode dummy triangles attached to these dummy points, but the 3D positions of those points are not encoded or decoded. In some embodiments, the vertex attributes are quantized if needed. Those attributes can be provided to the coder already quantized.

Example embodiments encode the connectivity of the mesh at 304 using a modified version of the edgebreaker algorithm from which generates a CLERS table (a table made of ‘C’, ‘L’, ‘E’, ‘R’, and ‘S’ symbols). This stage also generates some tables in memory that are used for the attribute prediction stage. The vertex attributes are then predicted, starting by the position ones. Then, other attributes are predicted 306, eventually relying on the position predictions, which is the case for the texture UV coordinates. The prediction may proceed in a topology-based order determined by the edgebreaker encoding. Alternatively, the prediction may proceed using a different order, such as a depth-first traversal or a vertex-degree-based traversal. At 308, the alternate traversal is performed. The encoder may signal in the bitstream information indicating which type of traversal is used for attribute prediction. The encoder may test different traversal types (e.g. a topology-based traversal type and one or more alternative traversal types) and encode the mesh using whichever traversal type provides the best performance (e.g. the greatest compression). Configuration and metadata are also provided in the bitstream, the CLERS table, some other connectivity and all the attribute prediction residuals are entropy coded 310 and added to the bitstream.

In an example decoding method, all of the entropy coded sub-bitstreams are decoded 312. We reconstruct the mesh connectivity 314 using the CLERS table and the edgebreaker algorithm. We also add some extra information to manage the handles, which describe the topology. We use the mesh connectivity as well as a minimal set of vertex positions expressed in 3D coordinates to predict all the other per-vertex positions 316. Where the traversal type is an alternative traversal type, the decoder performs the appropriate alternative traversal at 318. Where the traversal type is based on the topology of the mesh as reconstructed in 314, an alternative traversal is not needed. We then apply the attribute residuals to correct the predictions and obtain the reconstructed vertex positions. Then the other attributes are decoded, potentially relying on decoded positions, as for UV coordinates. The connectivity of attributes using separate index tables is reconstructed using per a per edge binary seam information that is entropy coded.

In a post-processing stage 320, we do remove the dummy triangles, we optionally recreate the non-manifold issues in case the coder is configured to perform lossless coding, and we optionally dequantize the vertex attributes if the model was quantized by encoder.

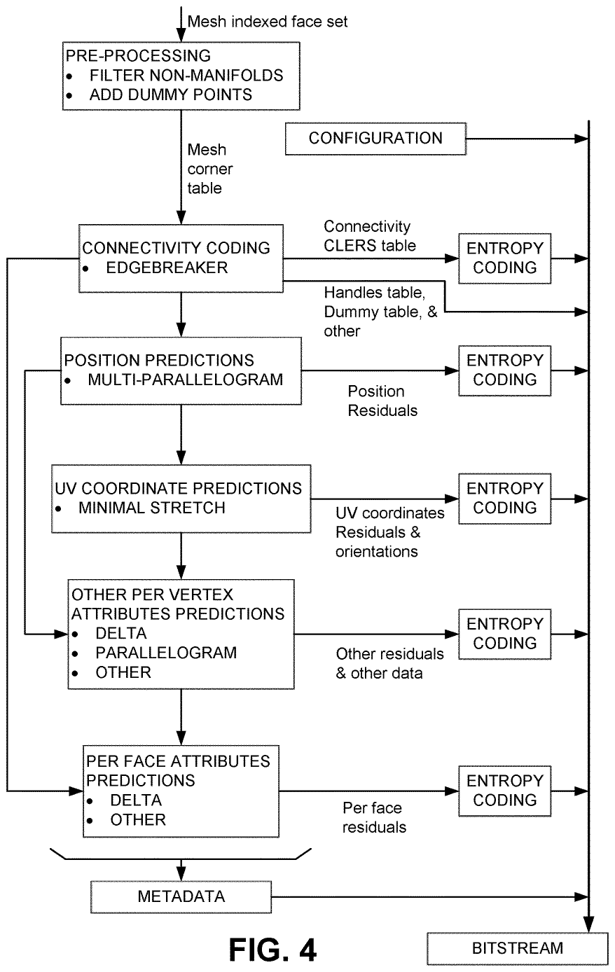

FIG. 4 is a flow chart of an encoding process according to some embodiments.

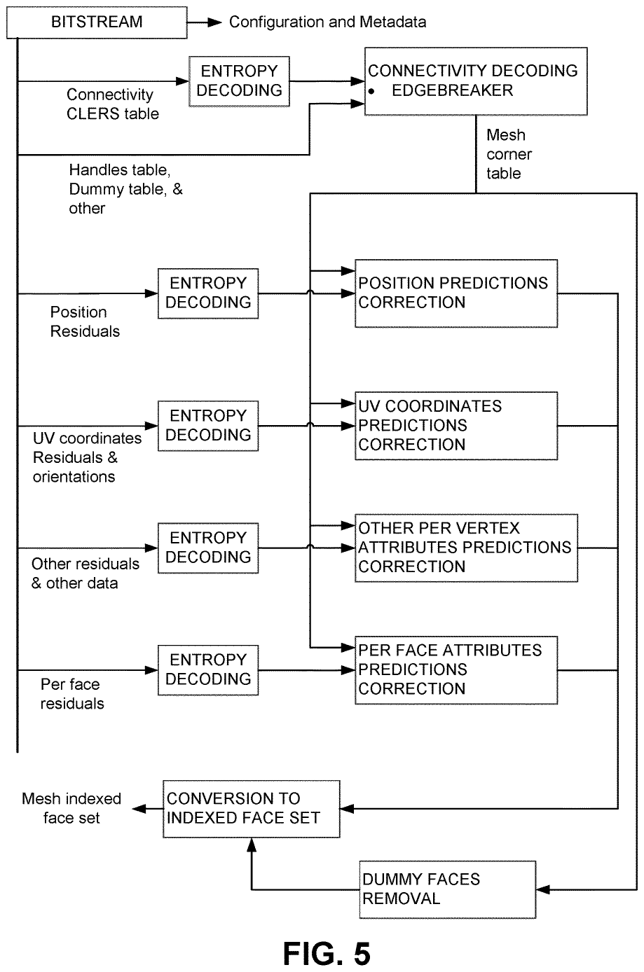

FIG. 5 is a flow chart of a decoding process according to some embodiments.

### Extended Corner Table.

A corner table data structure to represent a mesh is described in J. Rossignac, “3D compression made simple: Edgebreaker with ZipandWrap on a corner-table,” in Proceedings International Conference on Shape Modeling and Applications, Genova, Italy, 2001; and further described in J. Rossigniac, “Course on triangle meshes and corner table,” 2006.

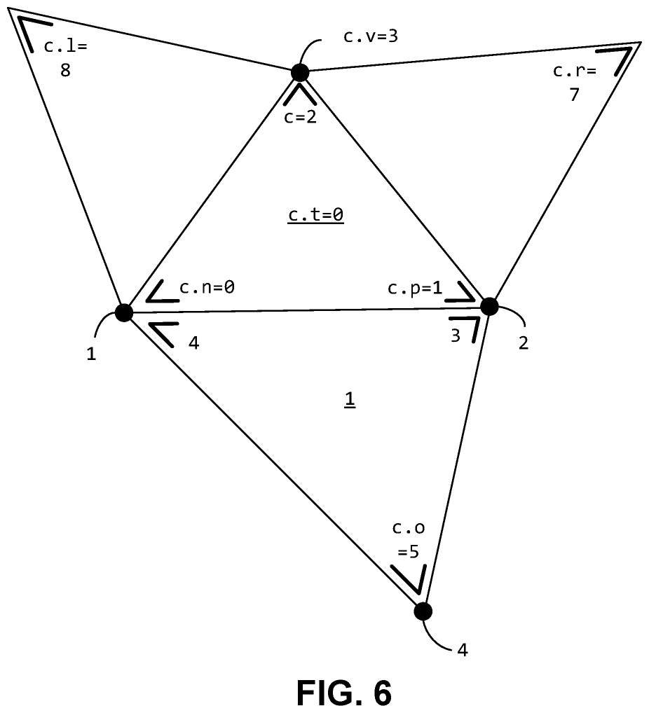

FIG. 6 illustrates a portion of a triangular mesh illustrating information that may be stored in a corner table (also referred to as an OV table). For each corner index c of a corner in the corner table, the notation c.v=3 identifies the index of the vertex at which that corner is located. The index c.t=0 is the index of the triangle that includes corner c. Within that triangle, the index c.n=0 identifies the next corner (in a counterclockwise direction), and c.p=1 identifies the previous corner. The index c.o identifies the corner that is opposite to the corner c. For example, in FIG. 6, corner c.o=5 is opposite corner c=2 (and vice versa). The index c.l identifies the corner to the left of corner c, and the index c.r identifies the corner to the right of corner c. The connectivity as shown in FIG. 6 may be recorded in a corner table with entries that include the following:

| | | Opposite |
|---|---|---|
| Corner | Vertex | Corner |
| Index | Index | Index |
| 0 | 1 | 7 |
| 1 | 2 | 8 |
| 2 | 3 | 5 |
| 3 | 2 | 9 |
| 4 | 1 | 6 |
| 5 | 4 | 2 |

The “corner index” column does not need to be stored in the table because it corresponds to the position of each row within the table. The triangle index for each corner can be calculated as

$$c . t = INT ( c / 3 )$$

Thus, corners 0, 1, and 2 are all in the triangle with index 0; corners 3, 4, and 5 are all in the triangle with index 1; and so on. Additional relationships among entries in the corner table may be expressed as follows:

$$c . n = 3 c . t + ( c + 1 ) MOD 3$$

$$c . p = c . n . n$$

$$c . l = c . p . o$$

$$c . r = c . n . o$$

In some embodiments, an additional table may be used to store position coordinates of each vertex.

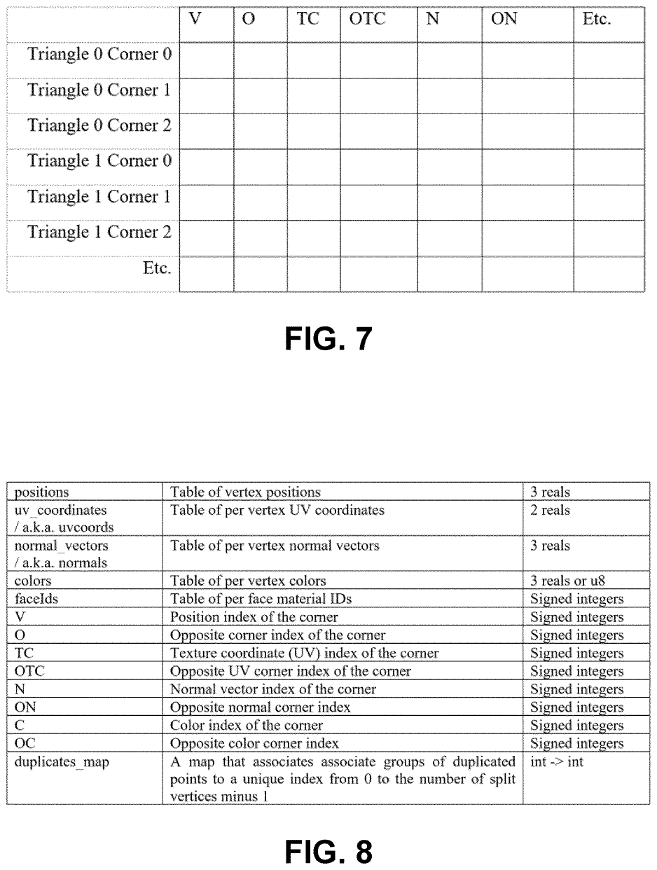

FIG. 7 illustrates an example of an extended corner table to support UV coordinates attribute and normal vector attributes, both using separate indexing tables, resp. TC/OTC and N/ON. Texture coordinates and normal vectors are stored in two other separate tables.

Example embodiments extend the corner table data structure to support other attributes with or without secondary attribute indices, as illustrated in FIG. 7. In case the mesh does not have separate indices to dereference the UV coordinates attributes, example embodiments include a table of UV coordinates alongside the position table. The UV coordinates table is then dereferenced using V as for the position. Otherwise, some embodiments also add two tables TC and OTC to code the connectivity of (to dereference) the UV coordinates. TC is used to store UV coordinates indices and OTC to store the opposite corners for the UV connectivity. The same principle may be applied to add support for per vertex normal (N/ON/normal_vectors) or per vertex colors (C/OC/colors).

FIG. 8 illustrates an extended Corner Table data structure used in some embodiments. As seen in FIG. 8, information from different columns of FIG. 7 (and/or additional information) may be stored in separate tables to provide more flexibility. FIG. 8 summarizes the data structures used in some embodiments to store the information of an extended corner table as used herein. This approach can be extended for any per vertex attribute type, to use or not dedicated index tables modeled using the pair (index table/opposite table). Per face IDs are included in the table in some implementations.

### Dummy Vertices.

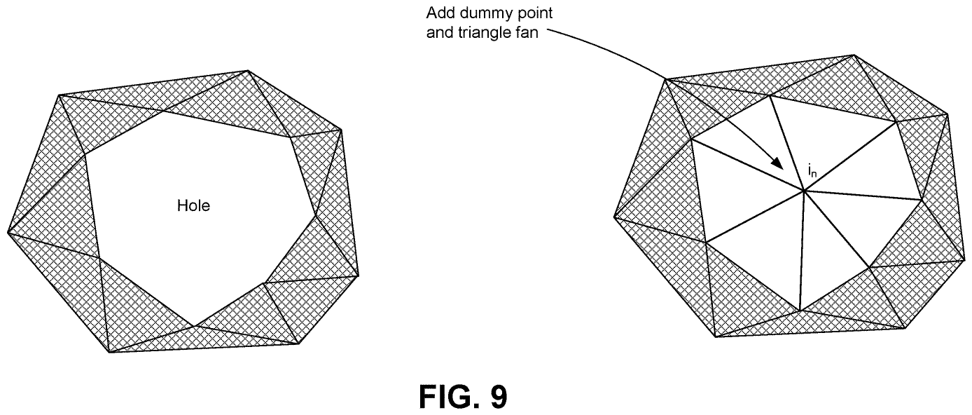

FIG. 9 illustrates a process in an example embodiment in which a hole in the surface of a mesh is filled with a dummy vertex and dummy triangles. In is the index of the dummy point in the vertex table

One known method of handling meshes with boundaries (also named meshes with holes) is to fill each hole with a dummy point and connect this new vertex to the border of the hole using a fan of triangles. The mesh is then encoded/decoded as if no hole was present. Some data to express which points are dummy is encoded in the bitstream so the point and its associated dummy triangles (from the fan) can be removed after the decoding. In some such techniques, the dummy points are encoded using fake attribute values (usually from interpolation). In other techniques, the indices of dummy points are tracked, and attributes (e.g. position, UV coordinates, color, etc.) of the dummy points are not encoded.

### Vertex Traversal.

In the current MEB version of Marvie & Mocquard, the vertex traversal used to perform the prediction of positions and the UV coordinates is the order deduced from the topology traversal performed by the edgebreaker algorithm. However, in some cases this traversal might not be optimal for the predictions, including the prediction of facelDs. For example, one may wish to compute the prediction from the neighborhood of a vertex vn in the EB order, whereas another vertex vₖ, which has also not yet been predicted, may have more already predicted neighbors leading to a better prediction.

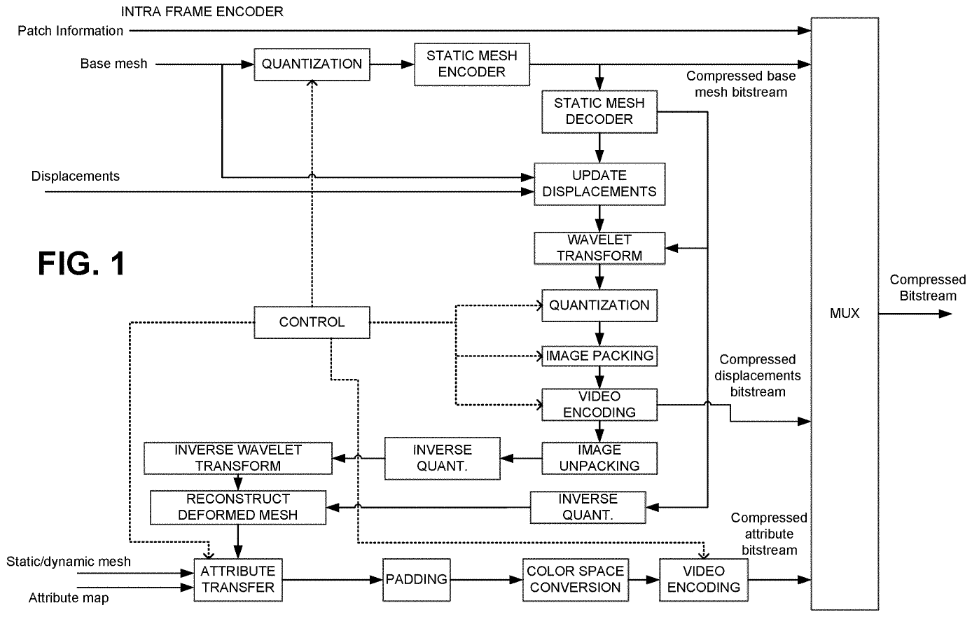

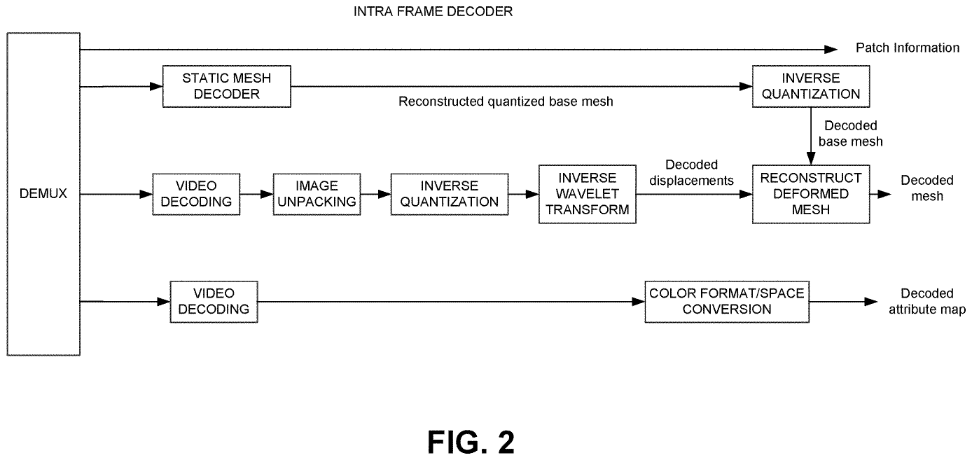

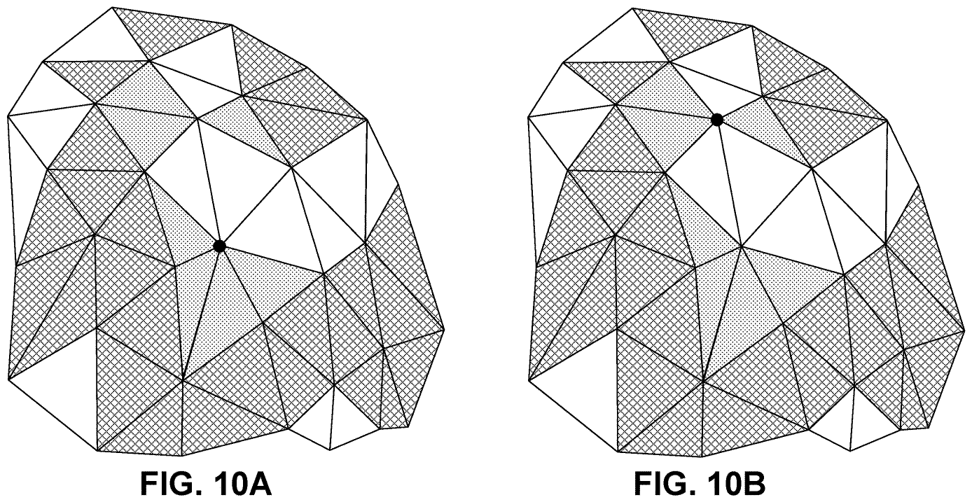

In D. Cohen-Or, R. Cohen and R. Irony, “Multi-way Geometry Encoding,” Transactions on Computational Science, 2002 (hereinafter Cohen-Or et al.), an approach of vertex traversal (ordering) is presented to improve the multi-parallelogram prediction for static meshes. FIG. 1 of Cohen-Or et al. provides a good visualization of multi-parallelogram prediction. FIGS. 10A-10B of the present disclosure illustrate the prediction degree of a vertex. Cross-hatched triangles are those in which all vertices have been traversed. The prediction degree of the bold vertex in FIG. 10A is four. The prediction degree of the bold vertex in FIG. 10B is three. To summarize, the prediction degree of a vertex is the number of neighbor “triangles” for which vertex predictions have already been solved by the decoder. Cohen-Or et al. proposes to perform an ordering (a vertex traversal) of the vertices to increase the average prediction degree of vertices as they are visited.

As discussed in Cohen-Or et al., computationally generating the traversal order might be costly. Google Draco implements a fast greedy version of this approach for their static mesh coder. Code for this approach is available at <https://github.com/google/draco/blob/master/src/draco/compression/mesh/traverser/max_prediction_degree_traverser.h>

This traversal improves the multi-parallelogram predictions once the topology is encoded/decoded by the edge breaker algorithm.

Google Draco also proposes another faster but less efficient depth first traversal method. Code for this approach is available at <https://github.com/google/draco/blob/master/src/draco/compression/mesh/traverser/depth_first_traverser.h>

Both may lead to better performances than basic EB traversal, with different complexities.

Some example embodiments described herein provide systems and methods for generating vertex traversal orders that accommodate meshes that include multiple connected components. Some such embodiments use table shifting to support the traversal of multiple connected components.

Some example embodiments described herein support the use of these methods of generating vertex traversal orders in systems and methods for the encoding/decoding of attributes using a main index table.

Some example embodiments described herein provide a syntax supporting the signaling of the traversal order used for the encoding and decoding of attributes. In some such embodiments, the syntax is included in the V3C syntax of the MPEG EdgeBreaker (MEB) to support the new possible modes of traversal.

Example embodiments operate on a corner table. Some such embodiments may be implemented using variations of the traversal functions of Draco as described above. The API and the implementation of the traversal functions may be adapted to support a table shifting method as used in Marvie & Mocquard to support multiple connected components of the mesh.

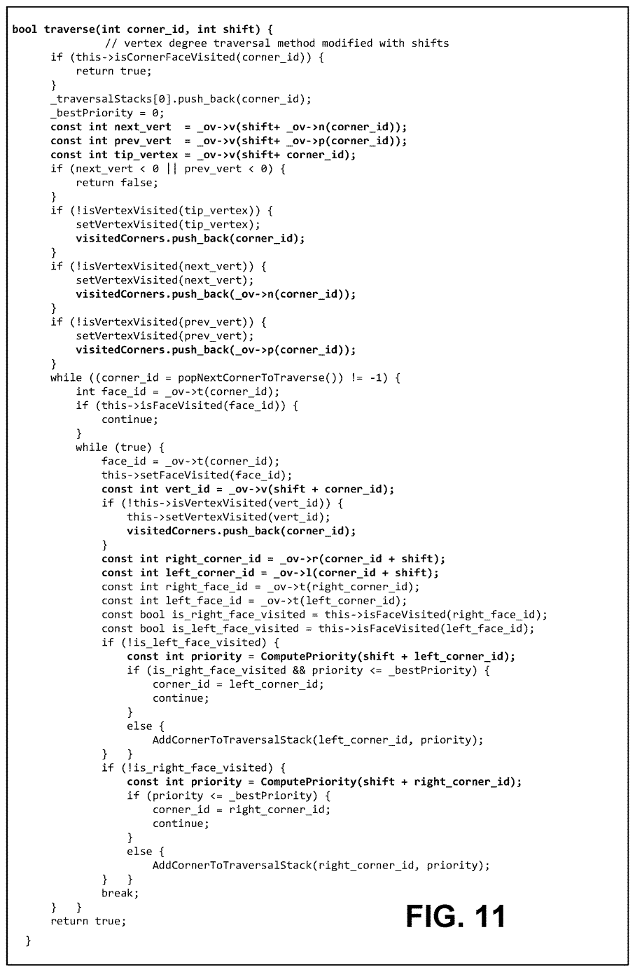

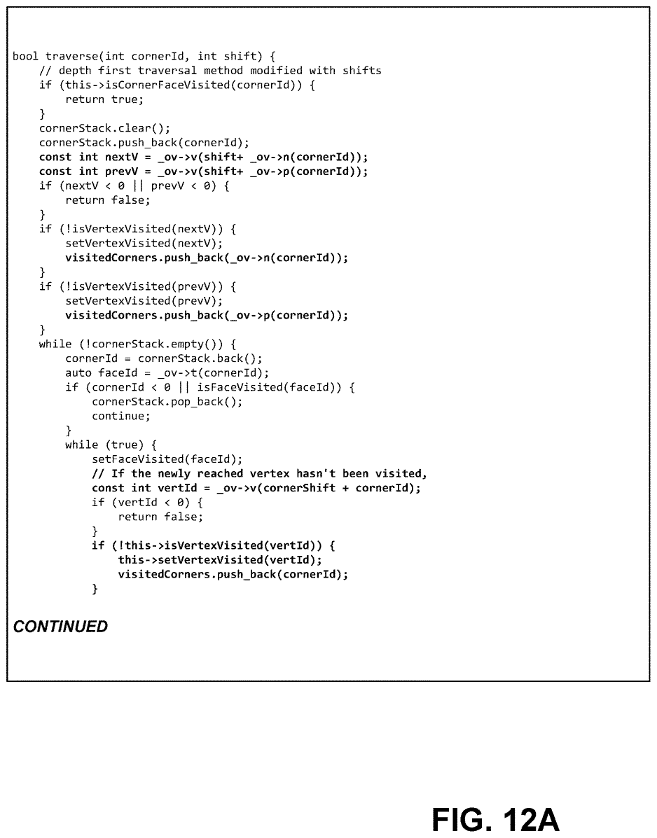

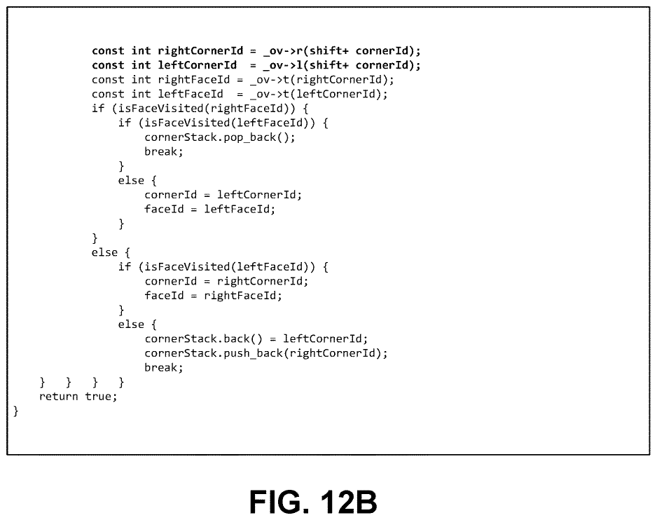

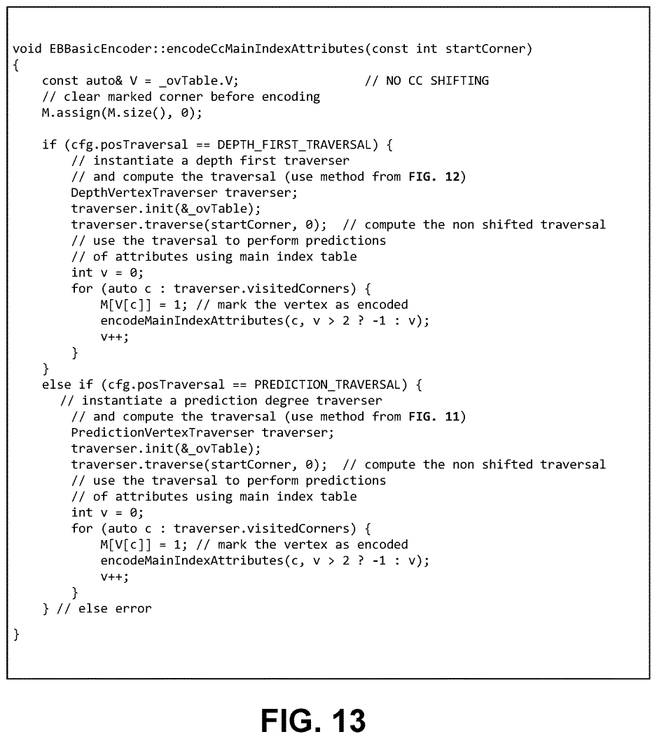

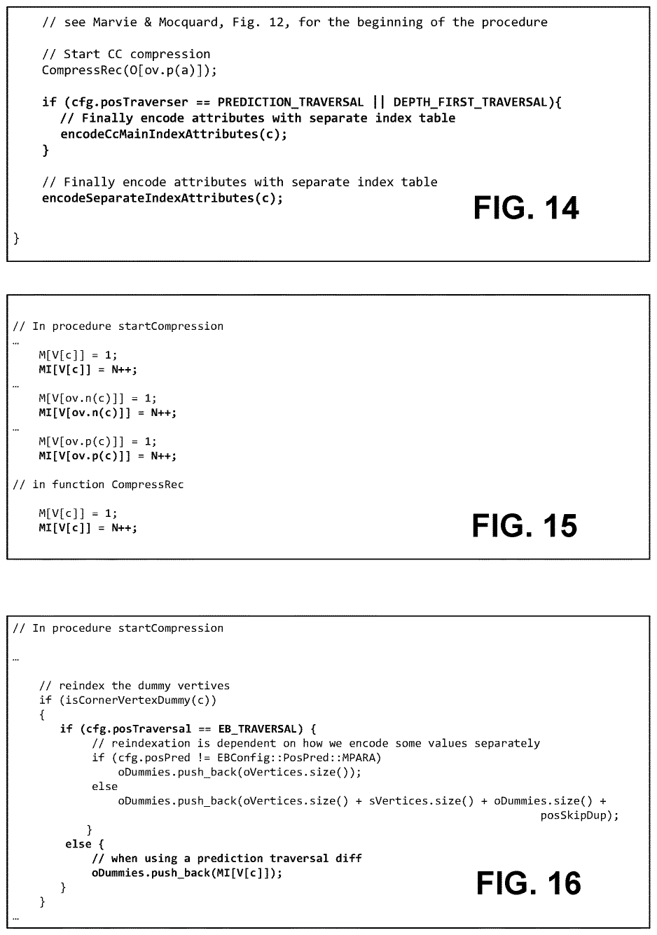

Code for an example vertex degree traversal method is illustrated in FIG. 11. Code for an example depth first traversal method is illustrated in FIGS. 12A-B. Portions of code that are of particular relevance to embodiments described herein are shown in boldface. One or both of those methods may then be used one or more times in a mesh encoding and/or decoding method to determine a vertex ordering. For example, those methods may be used in a mesh codec such as the codec disclosed in Marvie & Mocquard.

In some embodiments, the shifting is performed only at the decoding stage. In some embodiments, disabling the shifting is just performed by providing a shifting parameter set to 0.

In some embodiments, a vertex mesh codec stores a list of visited corners in an output table, such as visitedCorners instead of invoking a callback at each new visited vertex.

In example embodiments disclosed herein, the corners are shifted only where some right and left navigation (“I” and “n” method parameters is shifted) is performed on the topology and when retrieving vertex index (“v” method). The tip, next, previous, and triangle access and the visited corner added at the end of the visitedCorners table are not shifted (“n”, “p”, “t” and “push_back” method parameters are left unchanged). Shifting is also performed when computing the priority.

### Encoding Main Index Attributes.

In example embodiments, an encoder operates to encode the main index attributes for a connected component (CC) with a given start corner. In some such embodiments, a procedure such as the procedure encodeCcMainIndexAttributes of FIG. 13 is used. In some embodiments, this method may be invoked at the end of the startCompression method from (Marvie & Mocquard) as depicted in FIG. 14. Portions of code that are of particular relevance to embodiments described herein are shown in boldface. A current corner startCorner c is also provided as a parameter of encodeSeparateIndexAttributes, as described in greater detail below.

In this example, the option cfg.posTraversal may be one of the following options: [EB_TRAVERSAL, DEPTH_FIRST_TRAVERSAL or PREDICTION_TRAVERSAL].

In some embodiments, the lines of the procedures startCompression and CompressRec that contained a systematic call to encodeMainIndexAttributes are disactivated in case cfg.posTraverser is not set to EB_TRAVERSAL as follows:

if (cfg.posTraverser == EB_TRAVERSAL) {
encodeMainIndexAttributes( ... );
}

This way, in some embodiments, when options for depth first traversal or prediction degree traversal are activated, attribute prediction is deactivated from the topology encoding loop, the predictions are performed as a post process of the topology loop using the selected traversal.

### Dummy Points Indices Reordering.

In some embodiments, using the depth or degree traversal calls for a different ordering of dummy point indices at the encoding so that decoder can work in a simple manner for these cases.

In some such embodiments, a table MI is used to store, for each vertex index traversed by the topology step, a new index starting from zero and incremented at each use. For each line of the original code that affects a 1 to the table M of visited vertices we also add the index to table MI. Example code used for this feature (e.g. as an addition to the code of Marvie & Mocquard) is illustrated in FIG. 15, with added lines being shown in bold. Some embodiments use only the table MI without also using a table M. The information in table MI may then be used to construct an oDummies table inside the encodeMainAttributes procedure. The code from Marvie & Mocquard may be modified as depicted by FIG. 16, with added code being shown in bold.

Some embodiments further perform a sorting in ascending order of the oDummies table toward the end of the encoding method. Some embodiments may use an ordered set instead of a table to store the dummies, which would prevent the need for this last sorting since the dummy vertices are directly sorted upon addition to the set. The use of dummy vertices allows for a simpler implementation of the depth-first traversal method.

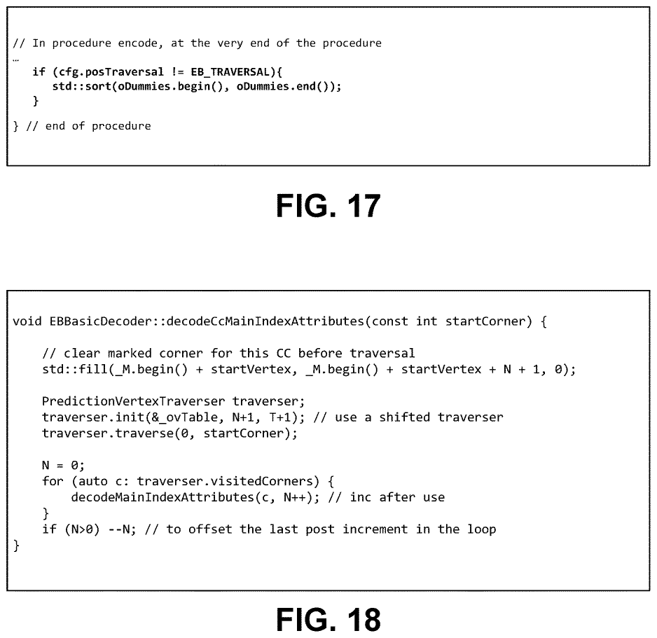

FIG. 17 illustrates an example of code used for ordering an oDummies table in some embodiments, with added code being shown in bold.

Reindexing and reordering of dummy vertices is performed to allow for proper operation of the decoder when using traversals other than the edgebreaker traversal.

### Decoding Main Index Attributes.

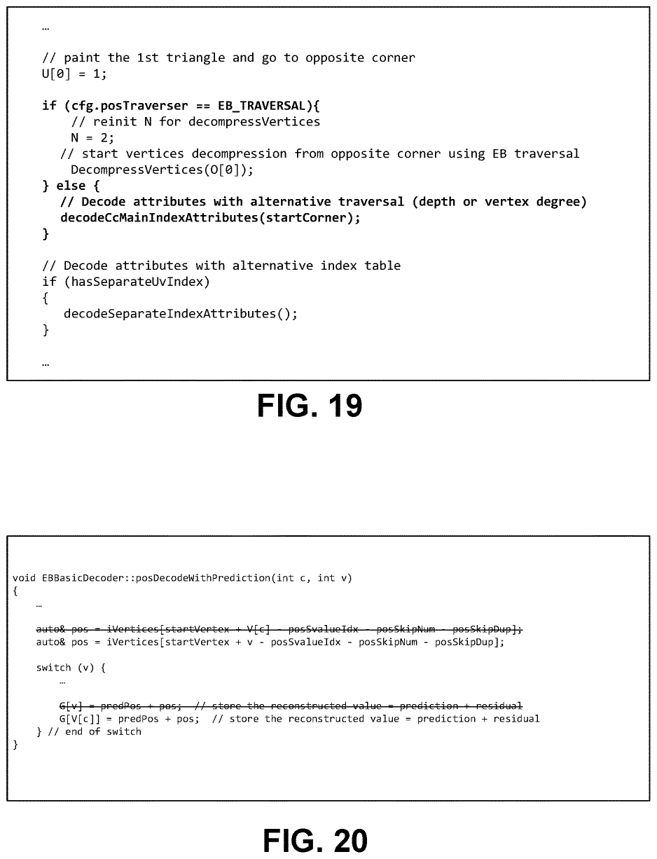

At the decoder side, example embodiments a procedure include decodeCcMainIndexAttributes to decode the main index attributes for a connected component (CC) with a given start corner. Code for an example of such a procedure is provided in FIG. 8. As illustrated in FIG. 19, this procedure may be invoked withing (e.g. at the end of) the startDecompression method from Marvie & Mocquard, as depicted in FIG. 19. FIG. 19 illustrates the procedure startDecompression to decode the attributes using main index with specific traversal. Code of particular relevance to the present disclosure is shown in bold. The option cfg.posTraversal is in [EB_TRAVERSAL, DEPTH_FIRST_TRAVERSAL or PREDICTION_TRAVERSAL].

In addition, the lines of the procedures startDecompression that contained a systematic call to decodeMainIndexAttributes may be deactivated in case cfg.posTraverser is not set to EB_TRAVERSAL as follows:

if (cfg.posTraverser == EB_TRAVERSAL) {
decodeMainIndexAttributes( ... );
}

In some embodiments, there is no specific handling of dummy points thanks to the reindexing and reordering that is performed at the encoding, hence reducing the decoder complexity.

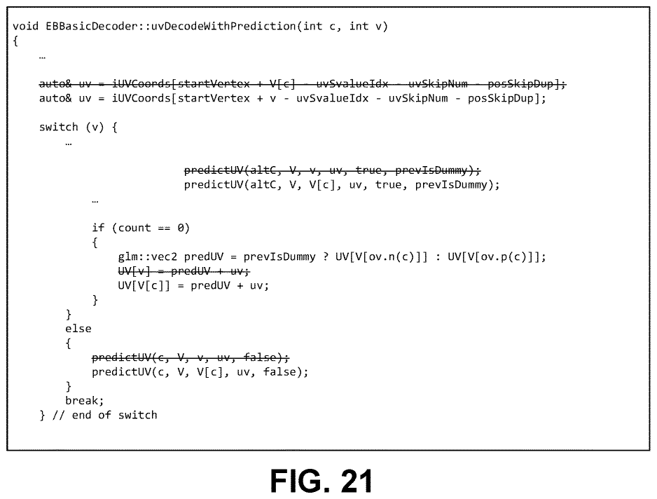

In some embodiments, the low-level prediction procedures at the decoder side are modified to use proper indexing. In Marvie & Mocquard, the v parameter was always aligned with V[c], but with a different traversal, example embodiments are adapted to properly use V[c], which is the new order from traversal, at several locations. Examples of such adaptations are illustrated in FIGS. 20 and 21. Compared to Marvie & Mocquard, added lines are shown in bold and removed lines are shown in strikethrough.

Encoding Attributes with Auxiliary Index Table.

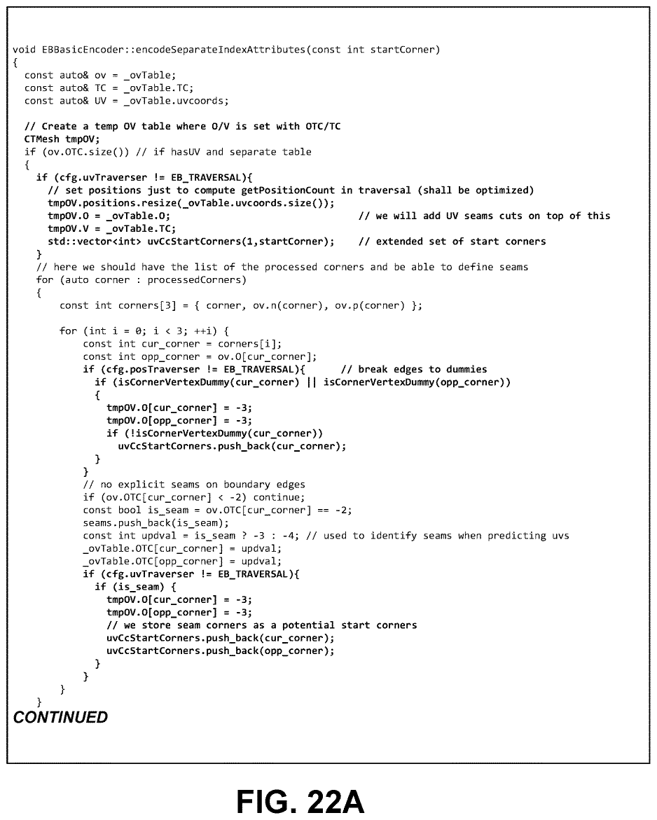

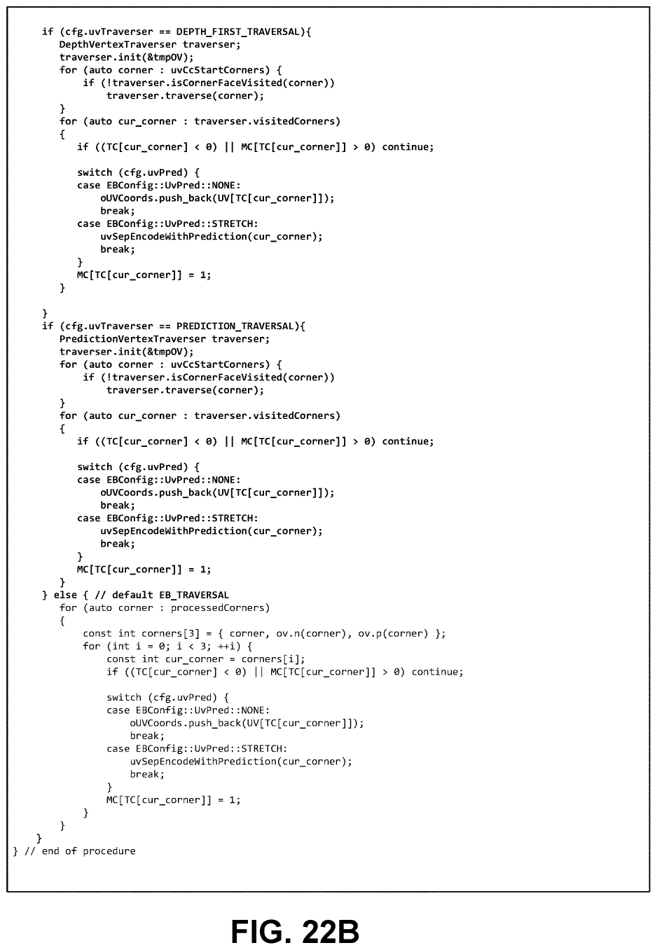

At the encoder side, example embodiments modify the procedure encodeSeparateIndexAttributes to encode the attributes, using auxiliary index table, for a connected component (CC) with a given start corner, as seen in FIGS. 22A-B. Code of particular relevance to the present disclosure is shown in boldface.

Some embodiments encode attributes in an auxiliary index table using an approach like the one using main index table. However, in addition, such embodiments are configured to handle the addition of seams, which cuts the topology into more connected components. In the example of FIGS. 22A-22B a temporary OV table is used to replicate the opposite information from the geometry part of main corner table (O) and copy the TC information in place of the V information. (This implementation detail may be used because the traversal works on O/V). This topology is then cut using the seams information from OTC. The result is a full topology of UVs in table O and associated UV indices in table V of the tmpOV corner table.

Since example embodiments include new connected components, the uvCcStartCorners set is supplemented with appropriate information. However, absent information regarding which corner to use as a start corner, all the corners are added from both sides of the seam (curr_corner and opp_corner) into the uvCcStartCorners (FIG. 22A). Later, the isCornerFaceVisited flag from the traversal is used to skip the redundant corners (FIG. 22B).

As in the example of FIGS. 22A-22B, the dummy points may be handled with a special case that does not store both sides of the seam into the uvCcStartCorners, but only the side where the current corner curr_corner is, through pushing only curr_corner when isCornerVertexDummy (opp_corner) is true and isCornerVertexDummy (curr_corner) is false.

Decoding Attributes with Auxiliary Index Table.

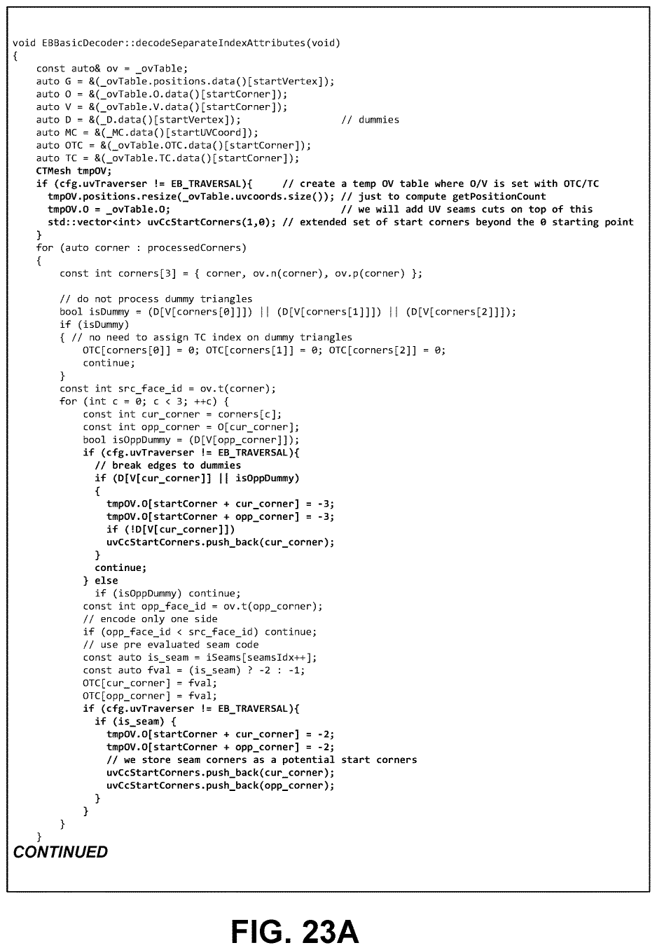

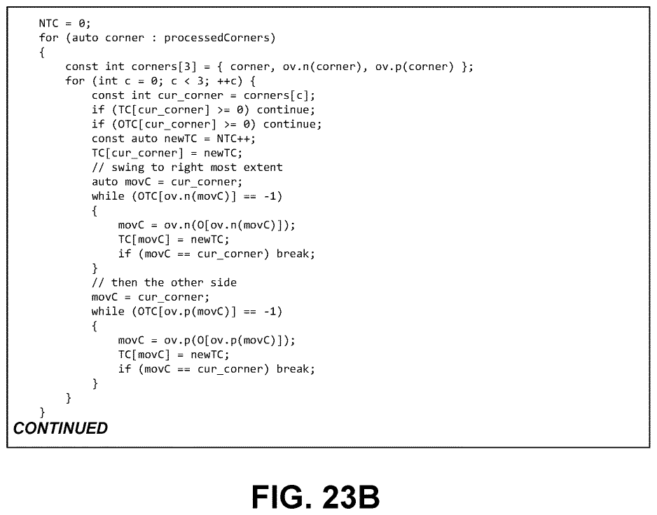

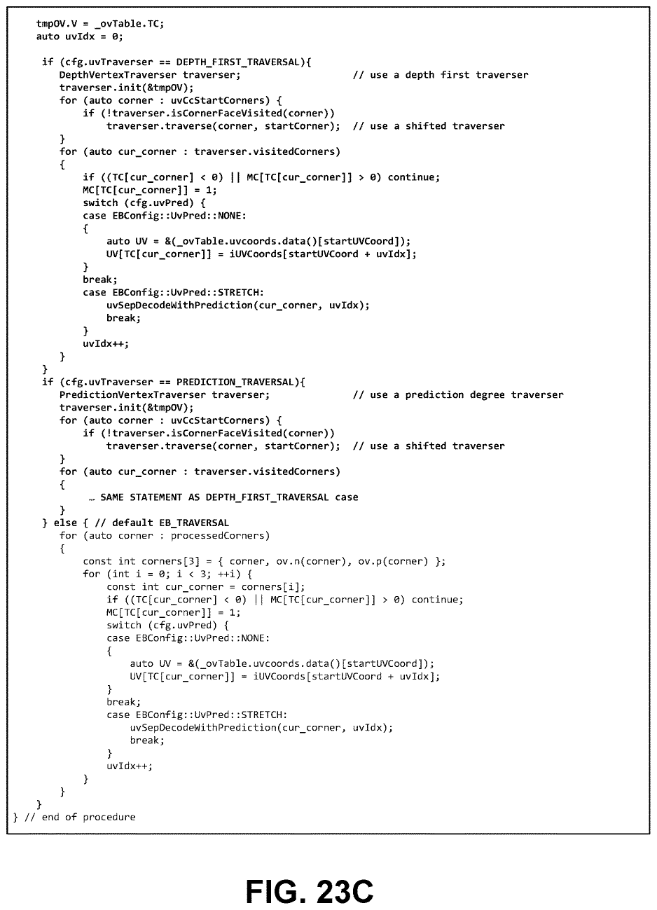

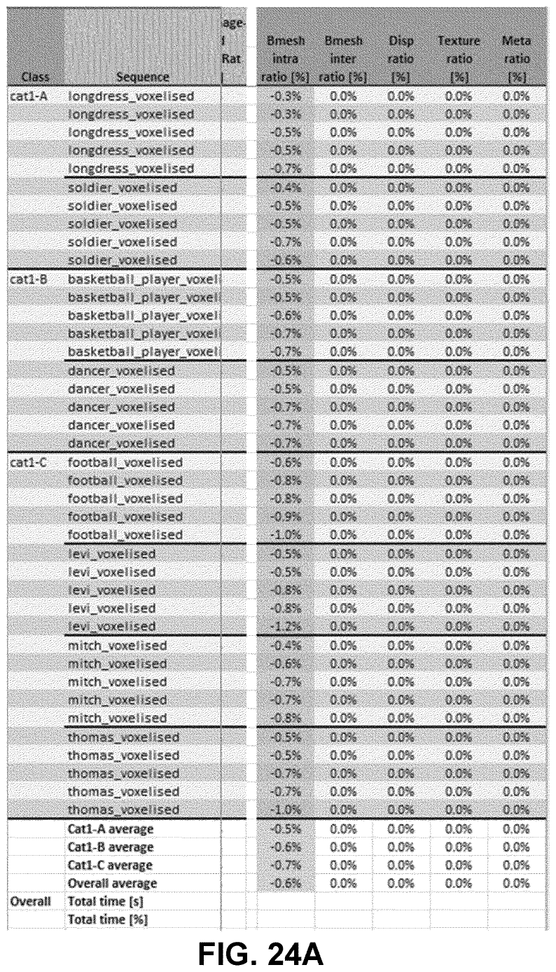

FIGS. 23A-23C illustrate examples of code that may be used in some embodiments in a procedure decodeSeparateIndexAttributes. Decoding of attributes in an auxiliary index table may be performed in three parts (FIG. 23A—Part1, FIG. 23B—part 2, FIG. 23C—part 3). In FIG. 23A, example embodiments apply the symmetrical work as for encoding to cut through the seams. Part 2 is left unchanged. Example embodiments then use the specific traverser in part 3 depending on the configuration.

### V3C Syntax

In practice it has been seen that using the most complex traversal is beneficial in terms of compression for at least two types of predictions: multi-parallelogram for positions and min-stretch for UV coordinates. Some example embodiments thus use a single traversal flag for all types of attributes. However, in other embodiments, a separate flag is signaled for each attribute type.

For the sake of explanation, example embodiments are illustrated here as variations of the V3C syntax of VDMC/MEB described in MDS22775_WG07_N00611_d9.

### Single Traversal Flag for all the Attribute Types.

To implement some example embodiments, the syntax “1.8.3.2 Mesh Coding Syntax” may be modified by adding the following line indicated with a dagger (t).

| | | Descriptor |
|---|---|---|
| mesh_coding_header( ) { | | |
| mesh_codec_type | | u(2) |
| mesh_vertex_traversal_method | † | ue(v) |

| | |
|---|---|
| mesh_position_encoding_parameters( ) | |
| mesh_position_dequantize_flag | u(1) |
| if (mesh_position_dequantize_flag ) | |
| mesh_position_dequantize_parameters( ) | |
| mesh_attribute_count | u(5) |
| for( i=0; i<mesh_attribute_count; i++ ){ | |
| mesh_attribute_type[ i ] | u(3) |
| if( mesh_attribute_type[ i ] == MESH_ATTR_TEXCOORD ) | |
| NumComponents[ i ] = 2 | |
| else if( mesh_attribute_type[ i ] == MESH_ATTR_NORMAL ) | |
| NumComponents[ i ] = 3 | |
| else if( mesh_attribute_type[ i ] == MESH_ATTR_COLOR ) | |
| NumComponents[ i ] = 3 | |
| else if( mesh_attribute_type[ i ] == MATERIAL_ID ) | |
| NumComponents[ i ] = 1 | |
| else if( mesh_attribute_type[ i ] == GENERIC ) { | |
| mesh_attribute_ num_components_minus1[ i ] | u(2) |
| NumComponents[ i ] = mesh_attribute_num_components_minus1[ i ]+1 | |
| } | |
| mesh_attribute_encoding_parameters ( i ) | |
| mesh_attribute_dequantize_flag[ i ] | u(1) |
| if (mesh_attribute_dequantize_flag[ i ] ) | |
| mesh_attribute_dequantize_parameters ( i ) | |
| } | |
| } | |

The semantics of the mesh_vertex_traversal_method element may be described as follows:
mesh_vertex_traversal_method specifies the method used to traverse the vertices to perform the prediction of all the vertex positions and vertex attributes.

Different values of the parameter mesh_vertex_traversal_method may represent different traversal methods. In some embodiments, the traversal methods represented are those in the following table.

| mesh_vertex_{—} | | |
|---|---|---|
| traversal_method | Identifier | Traversal Method |
| 0 | MESH_EB_{—} | Use Edge Breaker |
| | TRAVERSAL | topology traversal |
| | | as vertex order |
| 1 | MESH_DEPTH_{—} | Use depth first |
| | TRAVERSAL | traversal as |
| | | vertex order |
| 2 | MESH_DEGREE_{—} | Use prediction |
| | TRAVERSAL | degree traversal |
| | | as vertex order |
| >2 | | Reserved |

### One Traversal Flag for Each of the Attribute Type.

To implement some example embodiments, the syntax “1.8.3.3 Mesh position encoding parameters syntax” is modified by adding the following line marked with a dagger.

| | | Descriptor |
|---|---|---|
| mesh_position_encoding_parameters( ) { | | |
| mesh_position_bit_depth_minus1 | | u(4) |
| mesh_clers_symbols_encoding_method | | ue(v) |
| mesh_position_traversal_method | † | ue(v) |

| | |
|---|---|
| mesh_position_prediction_method | ue(v) |
| mesh_position_prediction_max_parallelograms_minus1 | u(4) |
| mesh_position_residuals_encoding_method | ue(v) |
| mesh_position_deduplicate_method | ue(v) |
| } | |

To implement some example embodiments, the syntax “1.8.3.5 Mesh attributes encoding parameters syntax” is modified by adding the following line marked with a dagger.

| | | Descriptor |
|---|---|---|
| mesh_attribute_encoding_parameters( index ) { | | |
| mesh_attribute_bit_depth_minus1[ index ] | | u(4) |
| mesh_attribute_per_face_flag[ index ] | | u(1) |
| if( !mesh_attribute_per_face_flag[ index ] ) { | | |
| mesh_attribute_separate_index_flag[ index ] | | u(1) |
| if( !mesh_attribute_separate_index_flag[ index ] ) | | |
| mesh_attribute_reference_index_plus1[ index ] | | ue(v) |
| } | | |
| mesh_attribute_traversal_method | † | ue(v) |

| | |
|---|---|
| mesh_attribute_prediction_method[ index ] | ue(v) |
| mesh_attribute_residuals_encoding_method[ index ] | ue(v) |
| } | |

Different values of the parameter mesh_position_traversal_method may represent different traversal methods. In some embodiments, the traversal methods represented are those in the following table.

The semantics of the mesh_position_traversal_method element may be described as follows:
mesh_position_traversal_method specifies the method used to traverse the vertices to perform the prediction of vertex positions and compute residuals mesh_position_residual[i][j].

Different values of the parameter mesh_position_traversal_method may represent different traversal methods. In some embodiments, the traversal methods represented are those in the following table.

| mesh_position_{—} | | |
|---|---|---|
| traversal_method | Identifier | Traversal Method |
| 0 | MESH_EB_{—} | Use Edge Breaker |
| | TRAVERSAL | topology traversal |
| | | as vertex order |
| 1 | MESH_DEPTH_{—} | Use depth first |
| | TRAVERSAL | traversal as |
| | | vertex order |
| 2 | MESH_DEGREE_{—} | Use prediction |
| | TRAVERSAL | degree traversal |
| | | as vertex order |
| >2 | | Reserved |

The semantics of the mesh_attribute_traversal_method element may be described as follows:

mesh_attribute_traversal_method specifies the method used to traverse the vertices to perform the predictions of the i-th attribute values and compute residuals mesh_attribute_residual[i][j] [k].

Different values of the parameter mesh_attribute_traversal_method may represent different traversal methods. In some embodiments, the traversal methods represented are those in the following table.

| mesh_attribute_{—} | | Traversal |
|---|---|---|
| traversal_method | Identifier | Method |
| 0 | MESH_ATTR_EB_{—} | Use Edge Breaker |
| | TRAVERSAL | topology traversal |
| | | as vertex order |
| 1 | MESH_ATTR_DEPTH_{—} | Use depth first |
| | TRAVERSAL | traversal as |
| | | vertex order |
| 2 | MESH_ATTR_DEGREE_{—} | Use prediction |
| | TRAVERSAL | degree traversal |
| | | as vertex order |
| >2 | | Reserved |

### Performance Results.

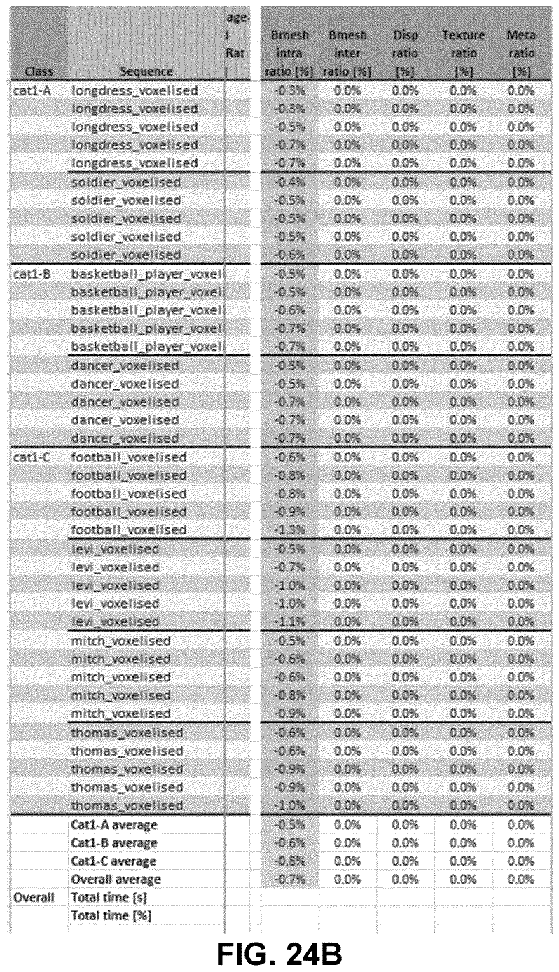

FIGS. 24A-24B illustrate performance results over 300 frames using degree traversal only for positions versus TMv4.0 Anchor. Base mesh size gains are expressed in percentages. FIG. 24A illustrates the AI condition, and FIG. 24B illustrates the LD condition. Note that the TM uses separate index tables for UV coordinates, hence the gain presented here is only due to the gain of new traversal for coding the positions.

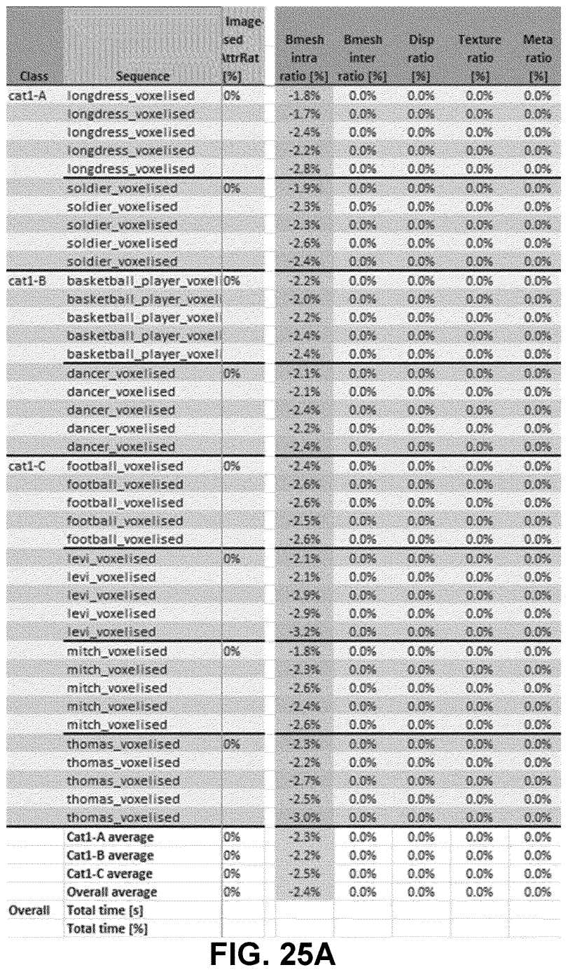

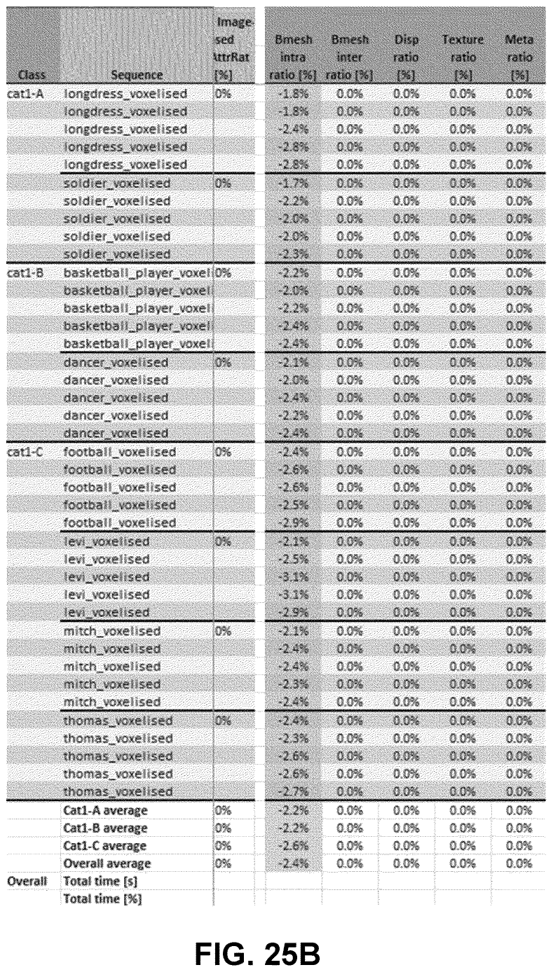

FIGS. 25A-25B illustrate performance results over 300 frames using degree traversal for both positions (main index) and UV coordinates (separate index) versus the current TMv4.0 Anchor. Base mesh size gains are expressed in percentages. FIG. 25A illustrates the AI condition, and FIG. 25B illustrates the LD condition.

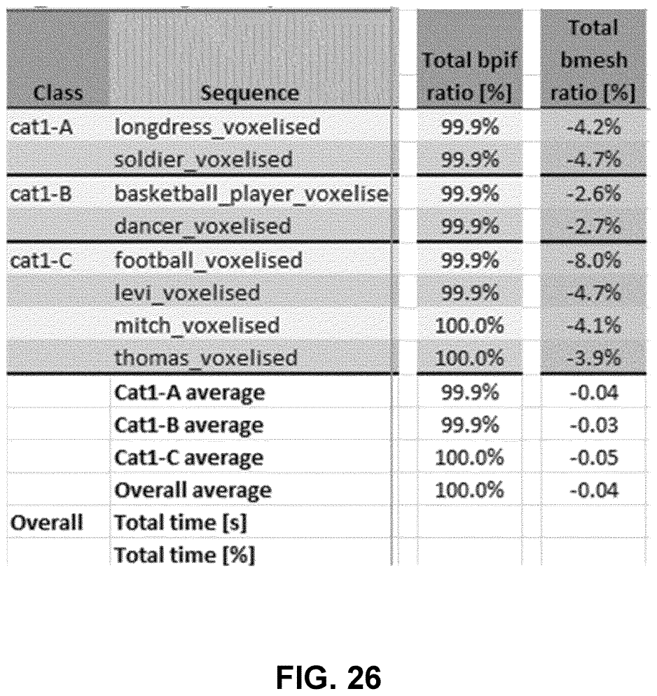

FIG. 26 illustrates performance results using lossless coding over 300 frames using degree traversal for both positions (main index) and UV coordinates (separate index) vs TMv4.0 Anchor using lossless conditions. Base mesh size gains are expressed in percentages. It can be see that gains can go up to 8% on some scenes for lossless condition and up to 3% on lossy conditions of the VDMC v4.0 CTCs.

### Example System Hardware

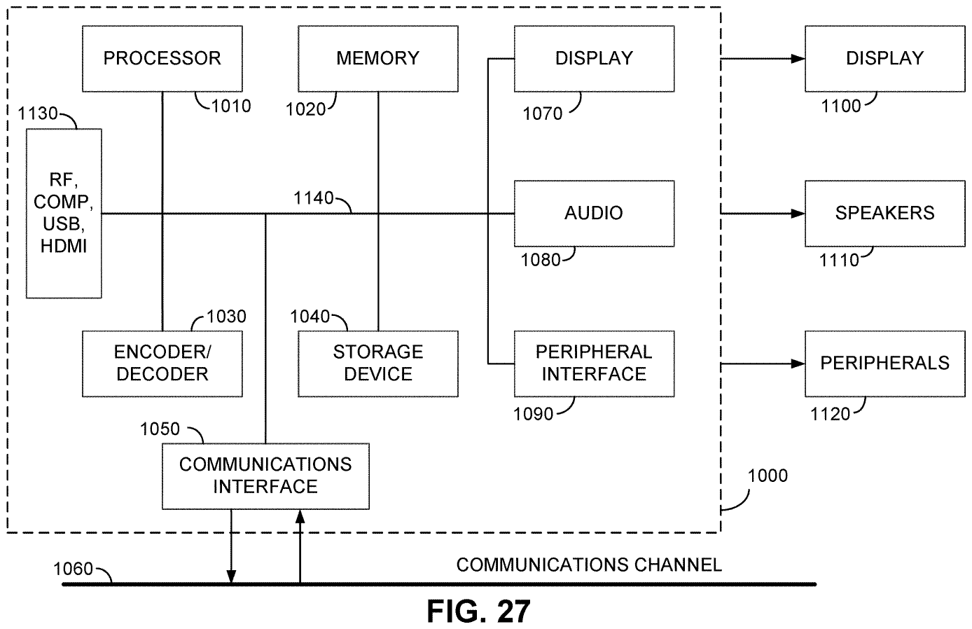

Example embodiments of encoders and/or decoders (collectively coders) configured to implement embodiments described herein may be implemented using systems such as the system of FIG. 27. FIG. 27 is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### Additional Embodiments

A mesh decoding method according to some embodiments includes: obtaining mesh information defining at least one connected component of a mesh; decoding at least a portion of the mesh information to generate at least one table, the table associating each vertex of the mesh with a respective first attribute value of a first attribute, the table having a first ordering of vertices; traversing the mesh to obtain a second ordering of the vertices; and decoding the first attribute values of the vertices according to the second ordering of the vertices.

In some embodiments, the mesh information defines a plurality of connected components of the mesh, and wherein traversing the mesh comprises traversing the plurality of connected components using table shifting.

In some embodiments, traversing the mesh comprises, at a current corner in a connected component of the mesh, determining an identifier of at least one candidate subsequent corner. An identifier of the at least one candidate subsequent corner is obtained in some embodiments by: shifting an identifier of the current corner by an amount associated with the connected component; and obtaining an identifier of the at least one candidate corner from a corner table based on the shifted identifier.

In some embodiments, the first attribute comprises at least one position coordinate of the respective vertex. In some embodiments, the first attribute comprises at least one UV coordinate of the respective vertex.

In some embodiments, the mesh information defining at least one connected component of a mesh is obtained in an edgebreaker format.

In some embodiments, the traversing is performed to increase an average prediction degree of the vertices between the first ordering and the second ordering. In some embodiments, the traversing is performed according to a vertex-degree-based traversal method. In some embodiments, the traversing is performed according to a depth-first traversal method.

In some embodiments, the decoding of the first attribute values comprises: for at least one current vertex in the mesh, predicting the first attribute value of the vertex based only on attribute values of one or more vertices preceding the current vertex according to the second ordering.

In some embodiments, the decoding of the first attribute values comprises: for each of a plurality of vertices in the mesh, predicting the first attribute value of the vertex based only on attribute values of one or more vertices preceding the respective vertex according to the second ordering.

In some embodiments, a decoding method further includes: obtaining, from a bitstream encoding the mesh information, information indicating whether to traverse the mesh to obtain a second ordering of the vertices, wherein the traversing of the mesh to obtain the second ordering is performed only in response to an indication to reindex the vertices.

In some embodiments, a decoding method further includes: obtaining, from a bitstream encoding the mesh information, information identifying a type of traversal, wherein the traversing of the mesh to obtain the second ordering is performed using the identified type of traversal.

A mesh decoding method according to some embodiments comprises: obtaining a table defining a connectivity of least one connected component of a mesh, the table comprising an ordered series of symbols; iteratively processing each of the symbols in the table, at least some of the iterations adding a vertex to the mesh according to a first ordering of the vertices; during each of a plurality of iterations that add a vertex to the mesh, decoding a respective first attribute value of a first attribute of the respective vertex; after the iterative processing of the symbols in the table, traversing the mesh to obtain a second ordering of the vertices; and decoding second attribute values of the vertices according to the second ordering of the vertices.

In some embodiments, the first attribute comprises at least one of: a position coordinate of the respective vertex or a UV coordinate of the respective vertex. In some embodiments, the second attribute comprises at least one of: a position coordinate of the respective vertex or a UV coordinate of the respective vertex.

A mesh decoding method according to some embodiments comprises: obtaining a table defining a connectivity of at least one connected component of a mesh, the table comprising an ordered series of symbols; obtaining information indicating whether a first attribute is coded using a vertex reordering; iteratively processing each of the symbols in the table, at least some of the iterations adding a vertex to the mesh according to a first ordering of the vertices; and decoding the first attribute according to whether a first attribute is coded using a vertex reordering, wherein, if the first attribute is not coded using a vertex reordering, the first attribute is decoded during each of a plurality of iterations that add a vertex to the mesh, and wherein, if the first attribute is coded using a vertex reordering, the first attribute is decoded after the iterative processing of the symbols in the table according to a second ordering of the vertices, the second ordering being obtained by traversing the mesh.

In some embodiments, the first attribute comprises at least one of: a position coordinate of the respective vertex or a UV coordinate of the respective vertex.

A mesh encoding method according to some embodiments comprises: obtaining mesh information defining at least one connected component of a mesh; decoding at least a portion of the mesh information to generate at least one table, the table associating each vertex of the mesh with a respective first attribute value of a first attribute, the table having a first ordering of vertices; traversing the mesh to obtain a second ordering of the vertices; and encoding the first attribute values of the vertices according to the second ordering of the vertices.

In some embodiments, the mesh information defines a plurality of connected components of the mesh, and wherein traversing the mesh comprises traversing the plurality of connected components.

In some embodiments, the first attribute comprises at least one position coordinate of the respective vertex. In some embodiments, the first attribute comprises at least one UV coordinate of the respective vertex.

In some embodiments, the mesh information defines at least one connected component of a mesh is obtained in an edgebreaker format.

In some embodiments, the traversing is performed to increase an average prediction degree of the vertices between the first ordering and the second ordering. In some embodiments, the traversing is performed according to a vertex-degree-based traversal method. In some embodiments, the traversing is performed according to a depth-first traversal method.

In some embodiments, the encoding of the first attribute values comprises: for at least one current vertex in the mesh, predicting the first attribute value of the vertex based only on attribute values of one or more vertices preceding the current vertex according to the second ordering.

In some embodiments, the encoding of the first attribute values comprises: for each of a plurality of vertices in the mesh, predicting the first attribute value of the vertex based only on attribute values of one or more vertices preceding the respective vertex according to the second ordering.

In some embodiments, information is signaled in the bitstream indicating that the first attribute values are encoded according to the second ordering.

In some embodiments, an encoding method further includes obtaining, from a bitstream encoding the mesh information, information indicating whether to traverse the mesh to obtain a second ordering of the vertices; wherein the traversing of the mesh to obtain the second ordering is performed only in response to an indication to reindex the vertices.

In some embodiments, an encoding method further includes: signaling, in a bitstream encoding the mesh information, information identifying a type of traversal, wherein the traversing of the mesh to obtain the second ordering is performed using the identified type of traversal.

A mesh encoding method according to some embodiments comprises: obtaining a table defining a connectivity of least one connected component of a mesh, the table comprising an ordered series of symbols; iteratively processing each of the symbols in the table, at least some of the iterations adding a vertex to the mesh according to a first ordering of the vertices; during each of a plurality of iterations that add a vertex to the mesh, encoding a respective first attribute value of a first attribute of the respective vertex; after the iterative processing of the symbols in the table, traversing the mesh to obtain a second ordering of the vertices; and encoding second attribute values of the vertices according to the second ordering of the vertices.

In some embodiments, the first attribute comprises at least one of: a position coordinate of the respective vertex or a UV coordinate of the respective vertex. In some embodiments, the second attribute comprises at least one of: a position coordinate of the respective vertex or a UV coordinate of the respective vertex.

A mesh encoding method according to some embodiments includes: obtaining a table defining a connectivity of least one connected component of a mesh, the table comprising an ordered series of symbols; making a determining of whether to encode a first attribute using a vertex reordering; iteratively processing each of the symbols in the table, at least some of the iterations adding a vertex to the mesh according to a first ordering of the vertices; encoding the first attribute according to whether a first attribute is coded using a vertex reordering, wherein, if the first attribute is not encoded using a vertex reordering, the first attribute is encoded during each of a plurality of iterations that add a vertex to the mesh, and wherein, if the first attribute is encoded using a vertex reordering, the first attribute is encoded after the iterative processing of the symbols in the table according to a second ordering of the vertices, the second ordering being obtained by traversing the mesh.

In some embodiments, the first attribute comprises at least one of: a position coordinate of the respective vertex or a UV coordinate of the respective vertex.

Further embodiments include encoder and/or decoder apparatus configured to perform the methods described herein. Such apparatus may include one or more processors configured to perform such methods. Some embodiments include an apparatus comprising at least one processor and a computer-readable medium (e.g. a non-transitory medium) storing instructions for performing any of the methods described herein.

Some embodiments include a computer-readable medium storing instructions for performing any of the methods described herein.

Some embodiments include a computer-readable medium storing a mesh encoded according to any of the encoding methods described herein.

Some embodiments include a signal conveying a mesh encoded according to any of the encoding methods described herein.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to mesh encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. A mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A mesh encoding method comprising:
obtaining input information defining at least one connected component of a mesh, the connected component having a plurality of vertices including a plurality of dummy vertices;
during a first traversal of the connected component to encode a topology of the connected component, assigning an index to each vertex representing an order in which the vertex is visited in the first traversal;
encoding at least one attribute of the connected component using a second traversal of the connected component, the second traversal using a different traversal order than the first traversal; and
encoding a table identifying the dummy vertices, each dummy vertex being identified by its associated index.

2. A mesh encoding apparatus comprising one or more processors configured to perform at least:
obtaining input information defining at least one connected component of a mesh, the connected component having a plurality of vertices including a plurality of dummy vertices;
during a first traversal of the connected component to encode a topology of the connected component, assigning an index to each vertex representing an order in which the vertex is visited in the first traversal;
encoding at least one attribute of the connected component using a second traversal of the connected component, the second traversal using a different traversal order than the first traversal; and
encoding a table identifying the dummy vertices, each dummy vertex being identified by its associated index.

3. The apparatus of claim 2, further comprising sorting the table in ascending order of indices.

4. The apparatus of claim 2, wherein obtaining input information defining at least one connected component comprises:
obtaining information defining an input mesh, the input mesh having a plurality of holes; and
for each of a plurality of the holes, adding a dummy vertex to fill the respective hole.

5. The apparatus of claim 2, wherein the input information defining the at least one connected component of a mesh comprises a corner table.

6. The apparatus of claim 2, wherein the encoding of the topology of the connected component is edgebreaker encoding.

7. The apparatus of claim 2, wherein the second traversal is performed according to a vertex-degree-based traversal method.

8. The apparatus of claim 2, wherein the second traversal is performed according to a depth-first traversal method.

9-11. (canceled)

12. A mesh decoding method comprising:
obtaining encoded information defining at least one connected component of a mesh, the connected component having a plurality of vertices including a plurality of dummy vertices;
obtaining a table identifying an index of each of the dummy vertices;
during a first traversal of the connected component to decode a topology of the connected component, identifying the dummy vertices based on the table; and
decoding at least one attribute of the connected component using a second traversal of the connected component, the second traversal using a different traversal order than the first traversal, wherein the attribute is not decoded for the identified dummy vertices.

13. A mesh decoding apparatus comprising one or more processors configured to perform at least:
obtaining encoded information defining at least one connected component of a mesh, the connected component having a plurality of vertices including a plurality of dummy vertices;
obtaining a table identifying an index of each of the dummy vertices;
during a first traversal of the connected component to decode a topology of the connected component, identifying the dummy vertices based on the table; and
decoding at least one attribute of the connected component using a second traversal of the connected component, the second traversal using a different traversal order than the first traversal, wherein the attribute is not decoded for the identified dummy vertices.

14. The apparatus of claim 13, wherein the table is sorted in ascending order of the indices.

15. The apparatus of claim 13, wherein the decoding of the topology of the connected component is edgebreaker decoding.

16. The method of claim 1, further comprising sorting the table in ascending order of indices.

17. The method of claim 1, wherein obtaining input information defining at least one connected component comprises:
obtaining information defining an input mesh, the input mesh having a plurality of holes; and
for each of a plurality of the holes, adding a dummy vertex to fill the respective hole.

18. The method of claim 1, wherein the input information defining the at least one connected component of a mesh comprises a corner table.

19. The method of claim 1, wherein the encoding of the topology of the connected component is edgebreaker encoding.

20. The method of claim 1, wherein the second traversal is performed according to a vertex-degree-based traversal method.

21. The method of claim 1, wherein the second traversal is performed according to a depth-first traversal method.

22. The method of claim 12, wherein the table is sorted in ascending order of the indices.

23. The method of claim 12, wherein the decoding of the topology of the connected component is edgebreaker decoding.
